(19) United States
(12) Patent Application Publication
(10) Pub. No.: US 2006/0048619 A1
(43) Pub. Date: Mar. 9, 2006

(54) Four sided cutter with relief

(75) Inventors: Michael J. Kelly, Red Lion, PA (US); Randall Terry, Defiance, MO (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 10/935,235

(22) Filed: Sep. 8, 2004

(51) Int. Cl. B26D 1/00

(52) U.S. Cl. 83/651; 83/946

(57) ABSTRACT

An apparatus for cutting a plastic object may include a blade. The blade may include a substantially flat base; a sloped wall coupled to and extending at an angle from the base; and a cutter edge coupled to the sloped wall. The base is recessed apart from the cutter edge. The apparatus may further include a mount for positioning the blade for cutting the plastic object. The cutter edge of the blade is for cutting the plastic object.

### BACKGROUND OF THE INVENTION

1. Field of the Invention

The present invention relates generally to the manufacture of plastic containers, and more particularly to removing extraneous plastic from a manufactured container.

2. Related Art

Conventional high speed chipless cutters used, for example, in the manufacture of plastic containers, have a blade design that can cause a pull-back area to appear on the top surface of the bottle where the blade is pulled back across the surface of the finished cut after the cut is complete. This is especially true when the plastic of the container is at a high enough temperature that the plastic is soft.

As seen, for example, in FIG. 1, a conventional cutter blade 100 has a substantially flat base 102 with four cutter edges 104a, 140b, 104c, and 104d (collectively 104) at the edges of the base 102. When a cutter edge 104 cuts a plastic bottle, the pull-back area is created by the drag of the base 102 behind the cutter edge 104.

This pull-back area may deform the plastic container, in particular, the closing mechanism on top of the container. The pull-back area may also otherwise cause the container or the container closure not to operate properly. Improperly manufactured containers waste manufacturing time and materials.

What is needed then is an improved blade that overcomes the shortcomings of conventional solutions.

### BRIEF SUMMARY OF THE INVENTION

In summary, an embodiment of the present invention may reduce the pull-back by installing a relief just past the cutting surface. This relief reduces the blade contact surface against the top of the bottle during pull-out of the blade, and presents an angled surface approach to the inner edge of the bottle to reduce any catching as the blade is pulled out.

In an exemplary embodiment, the present invention may be a apparatus for cutting a plastic object, comprising: a blade that comprises a substantially flat base; a sloped wall coupled to and extending at an angle from the base; and a cutter edge coupled to the sloped wall, wherein the base is recessed apart from the cutter edge; and a mount for positioning the blade for cutting the plastic object; wherein the cutter edge is for cutting the plastic object.

In another exemplary embodiment, the present invention may be a blade for cutting a plastic object comprising: a substantially flat base; a sloped wall coupled to and extending away from the base; and a cutter edge coupled to the sloped wall, wherein the base is recessed apart from the cutter edge.

In another exemplary embodiment, the present invention may be a method for cutting a plastic object comprising: providing an apparatus that comprises: a blade that comprises a substantially flat base; a sloped wall coupled to and extending at an angle from the base; and a cutter edge coupled to the sloped wall, wherein the base is recessed apart from the cutter edge; and moving the cutter edge into contact with the plastic object, thereby cutting the plastic object.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exemplary embodiment of a conventional four sided cutter blade; and

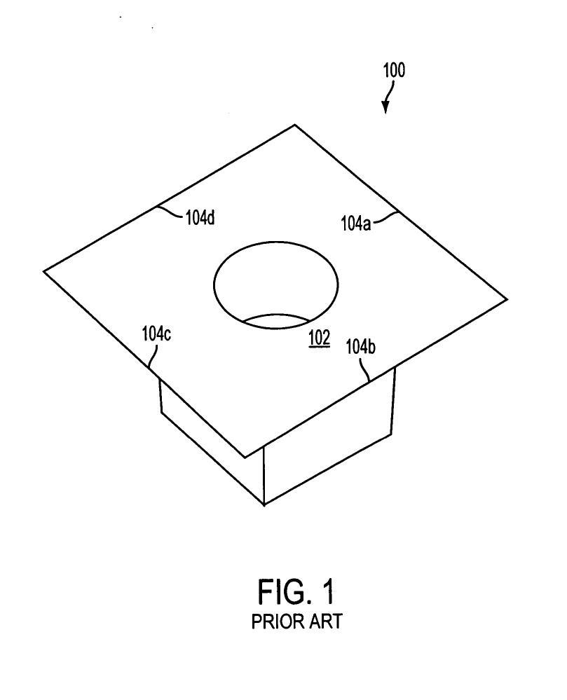

FIG. 2 depicts an exemplary four-sided cutter blade according to an embodiment of the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

In an exemplary embodiment, the present invention includes a cutter blade with a reduced cutter edge that touches the finished bottle surface, and a sloped relief in the form of a sloped wall behind the cutter edge to reduce catching during the pull-out of the cutter edge. Cutter blade integrity may be maintained by a tapered back side of the blade to compensate for the relief on the front. In an exemplary embodiment, a conventional mounting configuration may be used to mount the blade, so that no design changes to other machinery are needed to use the cutter blade of the present invention.

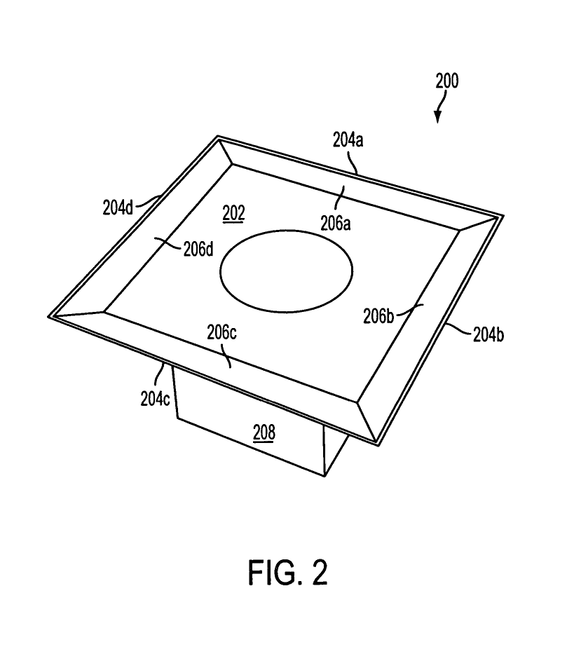

As seen in FIG. 2, an exemplary embodiment of a blade 200 according to the present invention may include a substantially flat base 202. In this embodiment, the base 202 is square-shaped, however, in practice, the blade may have any shape and may be symmetrical or asymmetrical. Each separate edge of base 202 has a sloped wall 206a, 206b, 206c, 206d (collectively 206). Each sloped wall 206 is coupled at its bottom to the base 202, and extends at an angle from the base 202. A sloped wall 206 may be linearly sloped. A sloped wall 206 may alternatively be curvilinearly sloped.

A separate cutter edge 204a, 204b, 204c, 204d (collectively 204) is coupled to each sloped wall 206a, 206b, 206c, 206d, respectively. The cutter edge 204 may be made of steel. The number of sloped walls and cutter edges is generally defined by the shape of base 202. For example, a six-sided blade may have six sloped walls and six cutter edges. A substantially circular base may have one continuous substantially circular sloped wall around its circumference, with one continuous substantially circular cutter edge. Substantially circular includes oval and elliptical bases.

Each cutter edge 204 is at an angle to the sloped wall 206, and can define a plane substantially parallel to the base 202. This results in the base 202 being recessed apart from the plane defined by the cutter edges 204. The blade 200 may also have a mount 208 for positioning the blade 200 for cutting the plastic object.

In embodiments that are not substantially circular, adjacent cutter edges may be joined together at their sides to form points. In some embodiments, one or more sloped walls may not have a cutter edge.

As a result of the recessed shaped of blade 200, when the cutter edge 204 is moved into contact with the plastic object, thereby cutting the plastic object, the plastic object does not substantially contact the base 202. Therefore, when the blade 200 is moved away from the cut plastic object, no pull-back area is formed.

The blade 200 may be mounted to a conventional cutter assembly, or may otherwise be mounted to be rotated relative to the plastic object.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. An apparatus for cutting a plastic object, comprising:
a blade that comprises
a substantially flat base;
a sloped wall coupled to and extending at an angle from said base; and
a cutter edge coupled to said sloped wall, wherein said base is recessed apart from said cutter edge; and
a mount for positioning said blade for cutting the plastic object;
wherein said cutter edge is for cutting the plastic object.

2. The apparatus of claim 1, wherein said base is set back from said cutter edge for avoiding contact between said base and the plastic object.

3. The apparatus of claim 1, wherein said base has a plurality of substantially straight sides, and the blade further comprises:
a plurality of sloped walls, each said sloped wall extending from one of said sides; and
a plurality of cutter edges, each said cutter edge coupled to a separate one of said sloped walls.

4. The apparatus of claim 3, the blade further comprising a point formed where one of said cutter edges contacts an adjacent one of said cutter edges.

5. The apparatus of claim 1, wherein said base has four sides, and the blade further comprising:
four sloped walls, each wall extending from a separate one of said four sides; and
four cutter edges, each cutter edge coupled to a separate one of said four sloped walls.

6. The apparatus of claim 5, the blade further comprising four points, each of said four points formed where one of said cutter edges contacts an adjacent one of said cutter edges.

7. The apparatus of claim 5, wherein said four cutter edges define a substantially square shape.

8. The apparatus of claim 1, wherein the base is substantially circular.

9. The apparatus of claim 1, further comprising means to rotate the blade relative to the plastic object.

10. The apparatus of claim 1, wherein said cutter edge comprises steel.

11. The apparatus of claim 1, wherein said cutter edge defines a plane substantially parallel to said base.

12. A blade for cutting a plastic object comprising:
a substantially flat base;
a sloped wall coupled to and extending away from said base; and
a cutter edge coupled to said sloped wall, wherein said base is recessed apart from said cutter edge.

13. The blade of claim 12, wherein said sloped wall is linearly sloped.

14. The blade of claim 12, wherein said sloped wall is curvilinearly sloped.

15. The blade of claim 12, wherein said cutter edge defines a plane substantially parallel to said base.

16. A method for cutting a plastic object comprising:
providing an apparatus that comprises:
a blade that comprises
a substantially flat base;
a sloped wall coupled to and extending at an angle from said base; and
a cutter edge coupled to said sloped wall, wherein said base is recessed apart from said cutter edge; and
moving said cutter edge into contact with the plastic object, thereby cutting the plastic object.

17. The method of claim 16, wherein the base does not substantially contact the plastic object when the cutter edge cuts the plastic object.

18. The method of claim 16, further comprising moving said blade away from the plastic object that is cut.

19. The method of claim 16, wherein said cutter edge defines a plane substantially parallel to said base.
